(19) United States
(12) Patent Application Publication
(10) Pub. No.: US 2007/0264613 A1
(43) Pub. Date: Nov. 15, 2007

(54) Dental implant

(75) Inventor: Stefan Ihde, Uetliburg (CH)

Correspondence Address: HUSCH & EPPENBERGER, LLC, 190 CARONDELET PLAZA, SUITE 600, ST. LOUIS, MO, 63105-3441, US

(73) Assignee: Biomed Est., Vaduz (LI)

(21) Appl. No.: 11/740,048

(22) Filed: Apr. 25, 2007

(30) Foreign Application Priority Data
Mar. 7, 2006 (DE) 20 2006 006 922.8
Apr. 25, 2006 (DE) 20 2006 006 920.8
May 24, 2006 (DE) 20 2006 008 702.8
Jun. 27, 2006 (DE) 20 2006 010 202.7

(51) Int. Cl. A61C 8/00

(52) U.S. Cl. 433/176; 433/173

(57) ABSTRACT

A dental or bone implant has a shaft with an oval to elliptical profile cross section 3, with its diameter D lying in the direction of insertion of the implant 1, forming the longitudinal axis of the shaft profile. The implant has a first bending zone 8, and the shaft 2 has another bending zone 10 in the vicinity of the implant foot 7 above the base disk 9. In addition, the basal and vertical parts of the implant are made of different biocompatible materials and a coating that delays osteonal remodeling of the jawbone in the vicinity of the implantation osteotomy, is applied to the enossal surfaces of the implant 1

### CROSS-REFERENCE TO RELATED APPLICATIONS

This application claims priority to U.S. application Ser. No. 11/506,614 filed Aug. 18, 2006. This application claims priority to international applications DE 20 2006 006 920.8 filed Apr. 25, 2006; DE 20 2006 003 922.8 filed Mar. 7, 2006; DE 20 2006 008 702.8 filed May 24, 2006; and DE 20 2006 010 202.7 filed Jun. 27, 2006.

### BACKGROUND OF THE INVENTION

1. Field of the Invention

The present invention concerns a dental implant which is anchored after insertion by basal osseointegration in the jawbone, and which serves as a base for holding and mounting an artificial tooth crown or a superstructure.

2. Related Art

Dental implants of the genus specified are generally known—EP 98250395.5, U.S. Pat. No. 4,815,974. They are undergoing continuous development and improvement, for example to reduce the trauma of pain, to shorten the healing period by forcing development of new bony tissue, and to achieve a long-lasting solid anchor in the jawbones. In spite of the continuing developments and improvements, the basic structural design of these implants, made up of a foot or base part, in the form of a disk or a ring, for instance, and a shaft arranged orthogonally to the foot or base part, remains unchanged.

Implants are made of biocompatible material with a view to bone integration. The principal materials considered for this purpose are titanium or its alloys with aluminum, vanadium, niobium, zirconium, or molybdenum.

If an implant with a relatively large implant foot or a relatively long implant shaft must be inserted into a bone that deforms elastically, it can happen that because the bone healing is biomechanically more favored, the vertical parts of the implant are osseointegrated into the cortex near the shaft before the basal parts of the implant. As a result, it may occur that as the vertical part of the implant functions, it follows the regions of bone surrounding it, while the basal part of the implant is not integrated, or is integrated only with a very low degree of mineralization, because it is moved away from the vertical implant parts. Implants integrated to that extent are only conditionally able to transfer forces effectively, because the basal parts of the implant are not anchored solidly enough in the bone. Therefore, undesired mobility of those implants cannot be excluded.

Dental implants anchored in the jawbone through basal osseointegration are inserted into the jawbone from the side, and a T-shaped implant bed is provided for such insertion by grinding. The vertical part of the implant bed, which provides for insertion and passage of the implant shaft, must be as narrow as possible so that the vertical slot that it makes in the jaw bond is closed again as rapidly as possible by the natural healing process. However, dental practice has shown that the width of the opening that must be ground out of the jawbone as the vertical part of the implant bed cannot be made arbitrarily narrow, because the shaft of an implant with a shaft diameter less than 1.6 mm usually breaks. The danger of breakage is considerably less even for a shaft cross-section with an outside diameter of 2 mm, while the danger of breakage for an implant shaft with a diameter of 2.3 mm or more is almost zero, and those shafts practically never break.

The vertical part of the implant bed that must be ground out for insertion and passage of an implant shaft having a diameter of 2.3 mm or more is a substantial invasion of the jawbone in relation to a relatively small alveolar ridge. Especially if several implant beds must be made in a jawbone to accept implants, the vertical slots add up to a bone defect that leads to shrinkage of the jaw caused by bone remodeling. In the upper jaw in particular, therefore, the vertical parts of the implant beds for implant shafts larger than 2.0 mm must be filled with bone replacement material after insertion of the implant. That, in turn, increases the cost of the whole treatment, and the danger of infections in the vicinity of the constructive material increases.

Maintaining the stability of implants with respect to the bones into which they are placed is anther problem. Mobility of implants is often observed both in orthopedic surgery and in dental and maxillofacial implantology. A certain portion of that mobility is due to infection. However, most of the mobility is caused by overloading the peri-implant bone. For instance, it is the most highly stressed screws, or the screws positioned in the least mineralized regions, such as in the tension or flexion regions of the bone, that become mobile in the case of fracture osteotomy plates.

The measures that have been known to limit or prevent these undesired processes amount to promoting new bone formation in the bony surgical region. Thus it has been suggested, among other things, to accelerate and stimulate the formation of new bony tissue by coating the implant surface with substances that promote bone growth.

Such procedures, and recommendations are, for instance, known from DE 600 19 752 T2, DE 196 30 034 A1 and DE 196 28 464 A1. They relate predominantly to improved preparation of substrates for bone development, such as tricalcium phosphate, hydroxyapatite, and all sorts of calcium and phosphorus compounds.

Measures for improved blood supply to the bone were also recommended to accelerate and stimulate formation of new bone tissue. Finally, increased provision of growth hormones and peptides of all types, which accelerate bone development, have been recommended.

None of those efforts has yet resulted in an actual useful and good clinical result, and there has been no overwhelming success in clinical practice, as it takes many weeks to months before the newly formed bone truly mineralizes and becomes capable of bearing a load. The implant mobility mentioned occurs much sooner, though.

There is a need in the art to achieve the objective of making the required vertical opening of the implant bed in the jaw bone for insertion of the implant and acceptance of the implant shaft as small or narrow as possible, and reducing the elevated risk of breakage, due to such small size, of implant shafts used in these narrow vertical openings in the implant bed, while simultaneously improving the osseointegration characteristics of the implant and the possibilities for adapting the prosthetic part to the tooth position.

### SUMMARY OF THE INVENTION

The objective of the invention is minimization of the required surgery of the implant bed by alterations of the implant and provision of an implant with improved osseointegration properties and improved potentials for adaptation to the tooth positions of the patients.

According to the invention, the shaft of the implant 1 has an oval to elliptical profile cross section 3, with its diameter D lying in the direction of insertion of the implant 1, forming the longitudinal axis of the shaft profile. Aside from a first bending zone 8, the shaft 2 has another bending zone 10 in the vicinity of the implant foot 7 above the base disk 9. In addition, the basal and vertical parts of the implant are made of different biocompatible materials and a coating that delays osteonal remodeling of the jawbone in the vicinity of the implantation osteotomy, is applied to the enossal surfaces of the implant 1—FIG. 1.

In one embodiment, a dental implant inserted from the side into a surgically prepared implant bed and anchored in the jaw bone by basal osseointegration, comprises a foot or base part in the form of a disk or a ring; a shaft arranged orthogonally to the foot or base part, designed as a simple cementing post or as a thread carrier with an internal or external thread at the end to hold and fasten the structural part of an artificial tooth crown or a superstructure, the shaft (2) has a profile cross-section that differs from a circle; and the longitudinal axis (4) of this profile lies in the direction of insertion of the implant (1).

The shaft (2) may have an oval to elliptical profile cross-section (3). The profile cross section (3) that differs from a circle extends over the free length of the shaft (2) from the base disk (9) to below the thread (5) in the end of the shaft (2). The shaft (2) may be provided with an oval to elliptical profile cross-section in the vicinity of the implant foot (6), which [cross-section] is positioned in the jaw bone after insertion of the implant (1).

The bone or dental implant may advantageously have two bending zones (8, 10) provided in the elliptical-oval shaft (2). The dental implant may have a first bending (8) zone provided below the head region of the implant (1) or below the threaded head (5) or below an abutment, and a second bending zone (10) provided in the foot of the shaft (2) above the base disk (9).

The bone or dental implant may advantageously have a coating, the substances of which contain active ingredients which delay osteonal remodeling of the jaw bone in the vicinity of the implantation osteotomy, is applied onto the enossal surfaces of the implant (1).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1: A schematic representation of the implant according to the invention.

FIG. 2: Section A-A from FIG. 1.

FIG. 3 The implant according to the invention with two bending zones.

### Component Designations

1 Implant

2 Shaft

3 Profile cross-section

4 Longitudinal axis

5 Head threads

6 Implant foot

7 Pin

8 Bending zone

9 Base disk

10 Bending zone

### DETAILED DESCRIPTION OF THE PREFERRED EMBODIMENTS

The following description of the preferred embodiment(s) is merely exemplary in nature and is in no way intended to limit the invention, its application, or uses.

In contrast with previously known solutions, which have an implant shaft with a circular cross-section, the shaft of the implant according to the invention has an oval to elliptical profile cross-section. Its diameter D, which simultaneously forms the longitudinal axis of the shaft profile and which is arranged in the direction of insertion of the implant, is greater than 2.0 mm, and its diameter d, measured across the smaller axis of the profile, is less than 2.0 mm. In one preferred embodiment, the diameter D is 2.3 mm while a diameter of 1.9 mm is selected for diameter d.

Because of the shape of the shaft profile according to the invention, the vertical opening that must be made surgically in the jawbone can be chosen relatively small. Therefore relatively narrow vertical slots are ground in the jawbone for insertion of the implant. They close rapidly through the natural healing process. That is particularly advantageous for implants in the upper jaw.

It will hardly be necessary at all to use bone replacement material, which formerly had to be used to close wide vertical openings, because the newly forming bone tissue bridges over openings less than 2.0 mm in the jawbone in a very short time, often closing directly or by way of network bone.

On the other hand, the cross-section of the shaft that bears and transfers the load is not reduced, because of the oval to elliptical cross section of the profile. In spite of the smaller diameter d of the profile cross-section, which must be selected relatively narrow so that the implant can be inserted through a relatively narrow slot in the jawbone, the danger of breakage of the shaft with the profile cross-section according to the invention is not increased. For instance, the number of load cycles to breakage (for a diagonal load) in fatigue tests is doubled with the implant shaft according to the invention.

A further advantage of the profile cross-section according to the invention is seen in the fact that the forces caused by chewing are transferred more evenly to the implant base and into the jawbone by the oval to elliptical profile of the shaft.

The oval to elliptical cross-sectional profile of the shaft according to the invention can extend over the entire free length of the implant shaft to below the threaded head of the shaft. Then it transforms to a circular cross-section. As an alternative, only the partial segments of the implant shaft that lie within the jaw bone after insertion can be given an oval to elliptical profile cross-section.

The oval shaft offers a further advantage for basal implant with round base disks. These base disks are not secure against rotation, and can easily turn in the bone. The oval shape of the vertical part of the implant provides security against rotation for those implants, also. That is highly advantageous in clinical use.

According to a further advantageous feature, the shaft of the implant according to the invention has, aside from the arrangement of a first bending zone with reduced profile cross-section below the cementation head of the implant shaft (or below the threaded head or an abutment), which is itself known, an additional second bending zone separated from the first bending zone can be provided in the vicinity of the shaft foot, lying slightly above the base disk of the implant. This development has the advantage, in dental practice, that the implant head can be made parallel with the tooth position in the patient's mouth by means of the first, upper bending position, and the position of the vertical implant shaft can itself be changed, and optionally a subsequent parallelization of the implant head with the tooth position can be accomplished. By means of the recommended solution, the vertical part of the implant, i. e., the shaft, can be bent into a different direction than that of the head of the implant with the threaded portion or the abutment without having to be concerned with, or changing, the direction of insertion of the implant into the implant bed. The threaded portion or the abutment can then be shifted in position. That was impossible with only a single bending position in the shaft. It is critical for that, though, that the two bending positions be sufficiently separated from each other.

Further elaborating on of this design, the section of the implant shaft between the upper and lower bending zones can have a somewhat larger profile cross-section to make sure that the bendings to be done occur specifically in the region of the bending zones. That is accomplished by these zones being elliptical-oval, thus having more material than the bending regions, the circular diameters of which correspond approximately to the smaller diameter of the elliptical-oval regions.

Various solutions have been suggested to improve the osseointegration properties. In contrast with the previously known implants, the basal and vertical parts of the implant need not consist of the same material, but can be of different materials that differ with respect to their biocompatibility and with respect to bone integration. In this case, the materials are selected so that the basal parts of the implant are osseointegrated faster and better than the vertical parts of the implant.

One advantageous embodiment, for instance, consists of having the basal parts of the implant made of titanium or one of its implantable alloys, while the vertical parts of the implant are made of an alloy based on Co, Cr and molybdenum.

The different integration tendencies are also promoted by the surfaces of the implant parts being of different roughness. It is particularly advantageous for such basal implants that have a vertical shaft polished to mirror brightness while the base disks have a slight enlargement of the surface, which can be produced by sandblasting, for instance, or by mechanical application of a microstructure. It is found that there is an additional clinical advantage for extra-oral implants, i. e., implants for anchoring maxillofacial epitheses, if the vertical parts of the implant are not made of titanium but of materials that are more easily cleaned and less colonized by plaque, such as steel, CoCrMo or zirconium, or derivatives and alloys of them.

With respect to production, the basal and vertical parts of the implant are made separately and then combined by frictional or mechanical mating. Screw or bayonet connections are advantageous. Such connections are extraordinarily stable because of osseointegration and formation of new bone tissue.

Implants of the type according to the invention can be used to particular advantage if the vertical parts of the implant are connected separably with the base disk or disks. Then the base disks can be left in the bone while the vertical implant parts or pins fastened to them can be separated from the base disk and removed at the end of the use phase. The base disks remain in the bone, where they can even be reused later (for example, in fracture therapy in case of a subsequent fracture). In particular, a screw connection secured by a small spot weld allows such a reversible connection. On the other hand, the screw connection can also be reversibly secured by supplemental riveting or mechanical compression. It is necessary to make sure, in every case, that the forces that must be applied to disassemble the implant in the bone after the use phase are somewhat higher than those occurring in the use phase in that they differ in nature and direction.

The different material natures of the vertical and basal parts of the implant can also be realized according to the invention by applying a coating of a different material to the shaft or to the basal disk or disks, with those materials not being the same as the core material of the implant.

The invention further provides for coating the implants with substances which temporally and locally limit, inhibit, or prevent internal formation of new bone, known as ‘remodeling’, to improve osseointegration properties.

Such substances are used, for instance, to treat osteoporosis if there is a need to delay bone deterioration caused by remodeling. These substances affect the activity of the so-called osteoclasts. They reduce the activity, propagation, or motility of the osteoclasts, the cells that degrade bone. At the state of the art, those substances are administered orally or parenterally for general medical problems (such as osteoporosis).

These substances have substantial adverse effects in the area of implantology, though, if they are administered in that manner. For instance, very severe inflammations can occur after implantation, as in patients who have received enossal dental implants or surgical-orthopedic implants. The most feared complications are the notorious osteomyelitis (inflammation of the bone marrow) and osteonecrosis (death of bones without bacterial action). For those reasons, implantations in patients who are taking such substances for general medical reasons are now considered highly risky and essentially contraindicated. The reason is quite simple: because of the reduced activity of the osteoclasts, the bone is less ossified. As a result, it is more strongly mineralized and the blood supply that is important for defense is lacking. Now if such a damaged bone is exposed to surgery, unintended penetration of bacteria into the bony surgical field can occur. Then, because the blood supply is inadequate, those bacteria cannot be repelled by the body's immune system, and they can propagate.

Even entire regions of bone can die in the same manner under therapy with substances that prevent or hinder osteonal remodeling. It is often not realized that the bone is dead, because dead bone retains its structural integrity for a long time, and even when dead, can transfer force and appear as a morphologic structure.

On the other hand, overloaded bone with microdefects due to the use of substances that inhibit or prevent osteonal remodeling, plus the repair damages that are harmful with respect to structural integrity, breaks after only about six weeks.

Controlled histological studies on which the invention is based show that the severe side effects of the substances that prevent the osteonal system from developing and functioning can be avoided for the region of the implant by not administering those substances orally or parenterally, but locally as part of the actual surgery, microtherapeutically in a sense. Coating of the implant with the active substance is an advantageous form of application. As many implant surfaces have a certain roughness in any case, application of such a coating is not a problem.

It has also been found that both fat-soluble and water-soluble substances can be used equally well. Thus, a great range of substances can be used for the solution according to the invention: beyond the biphosphonates—namely etidronate, clodronate, tiludronate, pamidronate, alendronate, risedronate, ibandronate, and zoledronate—estrogens, TGF-beta, gallium nitrate, Plicamycin, Calcitriol, Calcetonin, and Bafilomycin are also materials suitable for implant coating according to the invention.

In searching for substances that can be used in the implant region to reduce osteonal activity in the vicinity of implants, but which are not toxic, it was further found that even a thin coating with pure sodium chloride has such a local inhibitory action on the osteoclastic activity involved in remodeling. Such a coating can be produced by immersing the implant (with a roughened surface of those parts integrated into the jawbone by way of osseointegration, if possible) in a sodium chloride solution (such as min. 0.9% sodium chloride) at the end of the cleaning procedure and then drying it carefully. Thus, a thin coating of pure sodium chloride remains on the surface. This layer dissolves in the fluid and in the local blood during and after insertion of the implant. That produces a site of higher salt concentration in the bone, which limits the implant. Histological examinations have shown that this concentration influences the remodeling. It is not sufficient for just the usual physiological solution of sodium chloride to be present. The concentrations in the surrounding bone must be far higher than those that occur physiologically in the blood.

The same is true for a thin, soluble coating with CaP, CaSO₄, and other bone substrate substances that exhibit an action similar to that of sodium chloride. It is the massive local elevation of the concentration of these substances and the rapid solubility of the substances that is critical. They cannot adhere firmly to the implant surface (as, for instance, the older CaP coating intended to be permanent, or earlier hydroxyapatite coatings) but must be able to diffuse easily into the adjoining osteonal systems.

Colloidally applied pure silver also exhibits particularly favorable properties, especially at a particle size of 0.0001-0.01 micrometers. It is already known that this substance inhibits bacterial colonization. It has been found, though, that cells appearing in osteonal systems are also inhibited by silver. Concentrations between 10 ppm and 1500 ppm exhibit particularly favorable effects in this connection.

So if a high ion or particle concentration is generated around the implant by means of the substances mentioned above, remodeling can be prevented for a certain period, namely until the implants become splinted orthopedically (by the prosthesis). If one selects non-toxic, degradable substances to achieve the effect as per the invention, they can easily be degraded later, so that the long-term osteopetrotic effect ceases and the peri-implantal bones regenerate normally with time. For example, colloidal silver can be attacked in the osteonal remodeling that occurs later and can be moved away in a subperiostal or endosteal direction, where it is eventually absorbed and then eliminated enterally without problems.

As a result of the coating according to the invention, there is a situation near the enossal implant surface in which the bone exhibits no spatially limited and almost no temporally limited repair signs. Thus, the implants also remain stable postoperatively.

The concentration of the substances used for the coating according to the invention decreases with time, due to simple diffusion. They are diluted by the liquid circulating in the bones and by the blood flow, so that their concentration decreases below the threshold of therapeutic activity and regular remodeling slowly becomes possible again. By that time, though, the implants are finally well integrated into the bone and damages from use (microcracks) which act on the bones can no longer accumulate with time with repair defects. The repair also proceeds more slowly.

It can be advantageous, likewise, to be able to combat any local infections or to prevent such infections prophylactically, to combine the previously named substances for coating with antibiotics. Individual substances suggested according to the invention are themselves antibiotically active, e.g., calcium sulfate, calcium phosphate, and silver. Thus it may be sufficient also to combine several of the substances named for the coating.

A further advantageous substance comprises the combination of a biphosphonate, such as ibandronate, with an antibiotic, such as Treacycline. The use of Bafilomycin alone, on the other hand, can develop both effects. In appropriate concentration, it acts as an antibiotic and also as an inhibitor of osteonal remodeling.

According to the subject of the present invention, the implant 1 comprises the implant foot 6, which can, for instance, be designed as a disk or a ring, and a shaft 2, connected to the implant foot by pins 7. The basal part of the implant, in the form of the base disk 9, and the vertical part of the implant, formed by the shaft 2, are advantageously made of materials with different biocompatibility with respect to bone integration. Thus, for example, the base disk 9 can consist of titanium or its alloys and the shaft 2 of steel. The basal and vertical parts of the implant are initially made separately and then joined by frictional or mechanical connections.

Shaft 2 itself can be made as a simple cementing post, or provided with a threaded end 5 or with an abutment to hold and fasten the structural part of a dental prosthesis.

Shaft 2 of the implant 1 has, according to the invention, an oval to elliptical profile cross-section 3. It is arranged in relation to the implant food 6 so that the longitudinal axis 4 of the profile cross-section 3, or the outside diameter D, lies in the direction in which implant 1 is forced into the previously prepared implant bed on insertion of the implant. The profile cross-section 3 according to the invention of the shaft 2 can extend over the entire free length of shaft 2 into the vicinity of the end of the shaft which, in the present example, is provided with a thread 5, or it can be provided only in the section of shaft 2 adjacent to the implant foot 6, which is in the jawbone after insertion of the implant 1.

According to a preferred embodiment, the outside diameter D of the shaft profile is 2.3 mm, while the diameter d is 1.9 mm.

So as to grind out the narrowest possible vertical slot for holding and passage of the implant in the jawbone, the diameter d of profile cross-section 3 should be less than 2.0 mm, and diameter D greater than 2.0 mm, depending on the chewing forces that must be transferred to the jawbone.

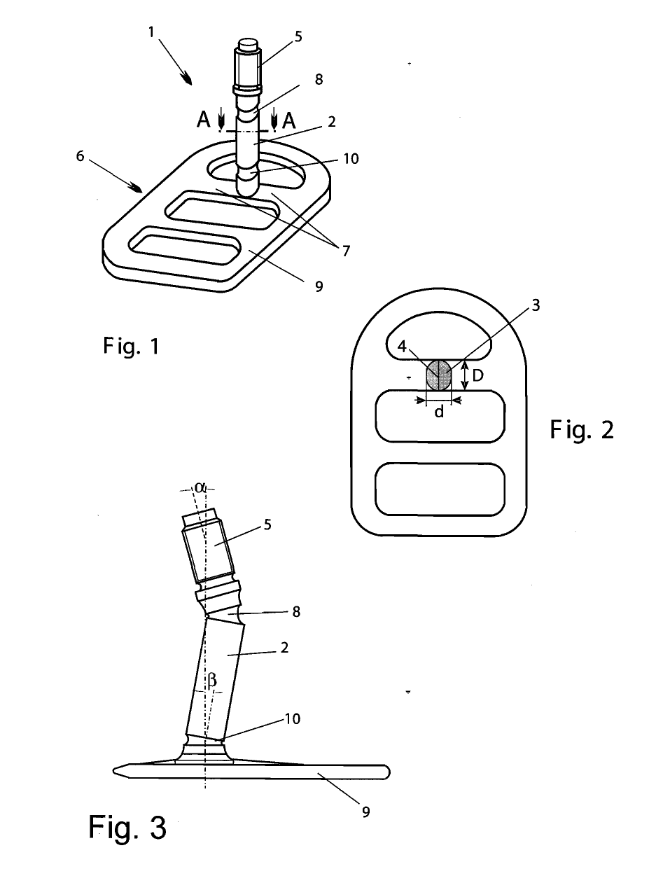

The implant 1 shown in FIG. 3, which differs from FIG. 1 in having a shaft 2 with circular cross-section, also has, in addition to the arrangement and design with a first bending zone 8 below the implant head, which is itself known, a further, second bending zone 10 in the vicinity of the implant foot 6, placed above the base disk 9. Aside from making the implant head parallel to the tooth position in the mouth of the patient using the upper bending zone, the position of the vertical implant shaft can itself be altered by means of the lower bending position. That, finally, provides a further additional possibility for parallelizing the implant head.

The enossal surfaces of the implant are provided, by known processes, with a roughened microporous surface structure onto which an adhesive water-soluble or fat-soluble Ibandronate solution is applied after cleaning of the implant to improve the osseointegration properties by temporal and local limitation of remodeling. The active ingredient occurs at a dosage of 3 to 8 mg in the coating on the enossal surfaces of the implant.

In one embodiment, an upper bending zone has a diameter that is thicker than a lower bending zone. After osseointegration over months or years, bone support protects the bending areas from masticatory stresses. The upper bending area receives less bone support than the lower bending area, and therefore, in the long term, has more stress applied to it. Accordingly, the upper bending area may advantageously be made thicker (stronger) than the lower bending area.

In the absence of the microporous surface structure, the adherent water-soluble or fat-soluble ibandronate solution of the stated dosage can also be applied directly onto the enossal surface of the implant. This coating is preferably applied to the enossal surface immediately before insertion of the implant, and the implant is inserted into the prepared cavity after the applied coating has dried.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A dental implant inserted from the side into a surgically prepared implant bed and anchored in the jaw bone by basal osseointegration, comprising:
a foot or base part in the form of a disk or a ring;
a shaft arranged orthogonally to the foot or base part, designed as a simple cementing post or as a thread carrier with an internal or external thread at the end to hold and fasten the structural part of an artificial tooth crown or a superstructure, the shaft (2) has a profile cross-section that differs from a circle; and
the longitudinal axis (4) of this profile lies in the direction of insertion of the implant (1).

2. A dental implant according to claim 1, characterized in that the shaft (2) has an oval to elliptical profile cross-section (3).

3. A dental implant according to claim 1, characterized in that the profile cross section (3) that differs from a circle extends over the free length of the shaft (2) from the base disk (9) to below the thread (5) in the end of the shaft (2).

4. A dental implant according to claim 1, characterized in that the shaft (2) is provided with an oval to elliptical profile cross-section in the vicinity of the implant foot (6), which [cross-section] is positioned in the jaw bone after insertion of the implant (1).

5. A dental implant according to claim 1, characterized in that the diameter D of the oval to elliptical profile cross section (3) is greater than 2.0 mm and is preferably 2.3 mm, and the diameter d is less than 2.0 mm and is preferably 1.9 mm.

6. A dental implant according to claim 1, characterized in that there are preferably two bending zones (8, 10) provided in the elliptical-oval shaft (2).

7. A dental implant according to claim 1, characterized in that a first bending (8) zone is provided below the head region of the implant (1) or below the threaded head (5) or below an abutment, and a second bending zone (10) is provided in the foot of the shaft (2) above the base disk (9).

8. A dental implant according to claim 1, characterized in that the profile cross-section of the bending zones (8, 10) is essentially round and the diameters of these zones correspond approximately to the smaller diameter (d) of the elliptical-oval profile of shaft (2).

9. A dental implant according to claim 1, characterized in that the basal part of the implant in the form of the base disk (9) and the vertical part of the implant formed by the shaft (2) are made from different biocompatible materials with respect to bone integration.

10. A dental implant according to claim 1, characterized in that the basal implant parts consist of titanium or its alloys.

11. A dental implant according to claim 1, characterized in that the vertical implant part consists of steel.

12. A dental implant according to claim 1, characterized in that the vertical implant part consists of a CoCrMo compound.

13. A dental implant according to claim 1, characterized in that the vertical implant part consists of CoCr in an alloy with other biocompatible materials.

14. A dental implant according to claim 1, characterized in that the vertical implant part consists of zirconium or a zirconium compound.

15. A dental implant according to claim 1, characterized in that the basal and vertical parts of the implant are made of a uniform core material and a surface coating of material different from that of the basal part of the implant is applied to the vertical part of the implant.

16. A dental implant according to claim 1, characterized in that the basal and vertical parts of the implant are made from a uniform core material and a surface coating of a material different from the material of the vertical part of the implant is applied to the basal part of the implant.

17. A dental implant according to claim 1, characterized in that the basal implant parts consist of titanium or its alloys.

18. A dental implant according to claim 1, characterized in that the connection between the basal and vertical parts of the implant is designed to be reversible.

19. A dental implant according to claim 1, characterized in that a coating, the substances of which contain active ingredients which delay osteonal remodeling of the jaw bone in the vicinity of the implantation osteotomy, is applied onto the enossal surfaces of the implant (1).

20. A dental implant according to claim 1, characterized in that the active substance in the coating is selected from the group of biphosphonates and the coating preferably contains etidronate, clodronate, tiludronate, pamidronate, alendronate, risedronate, ibandronate, zoledronate or combinations of them as the active substance.

21. A dental implant according to claim 1, characterized in that the active substance in the coating is selected from the group of estrogens and the coating preferably contains TGF-beta, gallium nitrate, plicamycin, calcitriol, calcetonin, bafilomycin or combinations of them as the active substance.

22. A dental implant according to claim 1, characterized in that the active substance in the coating is selected from the group of structural substances occurring in the bone or salts of the bone.

23. A dental implant according to claim 1, characterized in that the active substance in the coating is present at a concentration that is above the normal physiological concentration of that substance with respect to the blood concentration.

24. A dental implant according to claim 1, characterized in that the coating comprises sodium chloride.

25. A dental implant according to claim 1, characterized in that the coating contains a calcium compound.

26. Dental implant according to claims 1, characterized in that the coating contains calcium phosphate or calcium sulfate.

27 A dental implant according to claim 1, characterized in that the coating contains silver in an approximately pure form and this silver has a particle size of 0.001-0.01 micrometers.

28. A dental implant according to claim 1, characterized in that the substances of the coating which are active microtherapeutically and on osteonal remodelling are combined with substances having antibiotic activity.

29. A dental implant according to claim 1, characterized in that the coating contains an antibiotic which at the selected concentration inhibits osteonal remodeling at the same time.

30. A dental implant according to claim 1, characterized in that the coating exists in the form of an aqueous or oily solution, a gel, or a paste, and is applied to the enossal surfaces of the implant immediately before insertion, whereby the implant coated in that manner is inserted into the prepared implant bed after the coating has dried.

31. The dental implant of claim 7 characterized in that said second bending zone has a diameter narrower than a diameter of said first bending zone.
